(19) United States
(12) Patent Application Publication
(10) Pub. No.: US 2008/0106544 A1
(43) Pub. Date: May 8, 2008

(54) MOTION DETECTION APPARATUS AND METHOD APPLIED TO LIQUID CRYSTAL DISPLAY DEVICE

(75) Inventors: Chia-Hang LEE, Tainan County (TW); Fu-Chi Yang, Tainan County (TW); Cheng-Yi Chen, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/931,682

(22) Filed: Oct. 31, 2007

(30) Foreign Application Priority Data
Nov. 3, 2006 (TW) 95140701

(51) Int. Cl. G09G 5/00; H04N 5/14

(52) U.S. Cl. 345/214; 345/204; 348/699

(57) ABSTRACT

A motion detection method and an apparatus applied to a liquid crystal display device, are such that the method utilizes the steps of storing a first frame image in a storage unit at a first time, receiving the first frame image and a second frame image which is received at a second time, calculating a difference value of each pixel between the first frame image and the second frame image, and determining an adjustment value and a variance between the first frame image and the second frame image according to the result of the difference value of each pixel between the first frame image and the second frame image.

### CROSS REFERENCE TO RELATED APPLICATIONS

This Non-provisional application claims priority under 35 U.S.C. §119(a) on Patent Application No(s). 95140701 filed in Taiwan, Republic of China on: 2006/11/03 the entire contents of which are hereby incorporated by reference.

### BACKGROUND OF THE PRESENT INVENTION

1. Field of Invention

The present invention relates to a motion detection apparatus and method applied to a liquid crystal display device, and more particularly to a motion detection apparatus for effecting judgment and detection as to whether an inputted image signal is a still image or a motion image, so as to properly display the inputted image signal on the liquid crystal display device.

2. Description of Related Arts

When a direct-viewing or reflective LCD display apparatus serving as a hold-type display apparatus displays an image (an image object) that moves on its display screen, moving-image blur is perceived because the moving-image blur is caused by a displacement in an image formed on the retinas. In other words, in a “hold-type display apparatus”, display is held during the period of each frame. As a result, the motion blur and jerkiness is perceived when the “hold-type display apparatus” displays an image that moves on its display screen. As a result, image sticking or motion blur occurs whenever a motion image is displayed. To solve the problem, one prior art teaches an impulse type backlight driving method. However, the impulse type backlight driving method undesirably accounts for the flicker on the display screen. The flicker is conspicuous where the display screen displays a static image, as opposed to a motion image. In this regard, the prior art taught using a high frame rate to reduce the occurrence of the flicker whenever static images are displayed on the display screen. For instance, a frame rate of 60 Hz is increased to 90 Hz or 120 Hz. However, the method has its drawbacks, namely decreasing pixel charging time, signal attenuation, complicated driving circuits, and increased system load.

Motion compensation can be efficient or successful, depending on whether a motion vector is determined quickly and accurately by motion estimation. The prior art taught various fast algorithms for performing motion estimation, such as Full Search Algorithm, Full Search with Down-sampling Algorithm, Three-step Search with Down-sampling Algorithm, etc. However, as disclosed in the prior art, comparing a motion vector of an image with that of another image is an intricate job, whether it comes to calculation or hardware implementation.

### SUMMARY OF THE PRESENT INVENTION

A main object of the present invention is to provide a motion detection apparatus applied to a liquid crystal display device and a method of the same, wherein the motion detection apparatus effects judgment and detection as to whether an inputted image signal is a still image or a motion image so as to properly display the inputted image signal on the liquid crystal display device, thus enhancing the display performance of the liquid crystal display device.

Accordingly, in order to accomplish the one or some or all above objects, the present invention provides a motion detection apparatus applied to a liquid crystal display device, comprising:

a buffer for storing a first frame image received at a first time;

a subtractor electrically connected to the buffer for receiving the first frame image received at the first time and a second frame image received at a second time and calculating the difference value of each pixel between the first frame image and the second frame image; and

a threshold unit electrically connected to the subtractor for generating an overdrive value by the result of the difference value of each pixel between the first frame image and the second frame image so as to determine whether a variance between two adjacent frame images is present.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a block diagram showing a motion detection apparatus applied to a liquid crystal display device according to a first preferred embodiment of the present invention.

FIG. 2 is a flow chart showing how to calculate an overdrive value (ODV) of the first preferred embodiment of the present invention.

FIG. 3 is a block diagram showing a motion detection apparatus applied to a liquid crystal display device according to a second preferred embodiment of the present invention.

FIG. 4 is a flow chart showing how to calculate a modified overdrive value (MODV) of the second preferred embodiment of the present invention.

### DETAILED DESCRIPTION OF THE PREFERRED EMBODIMENT

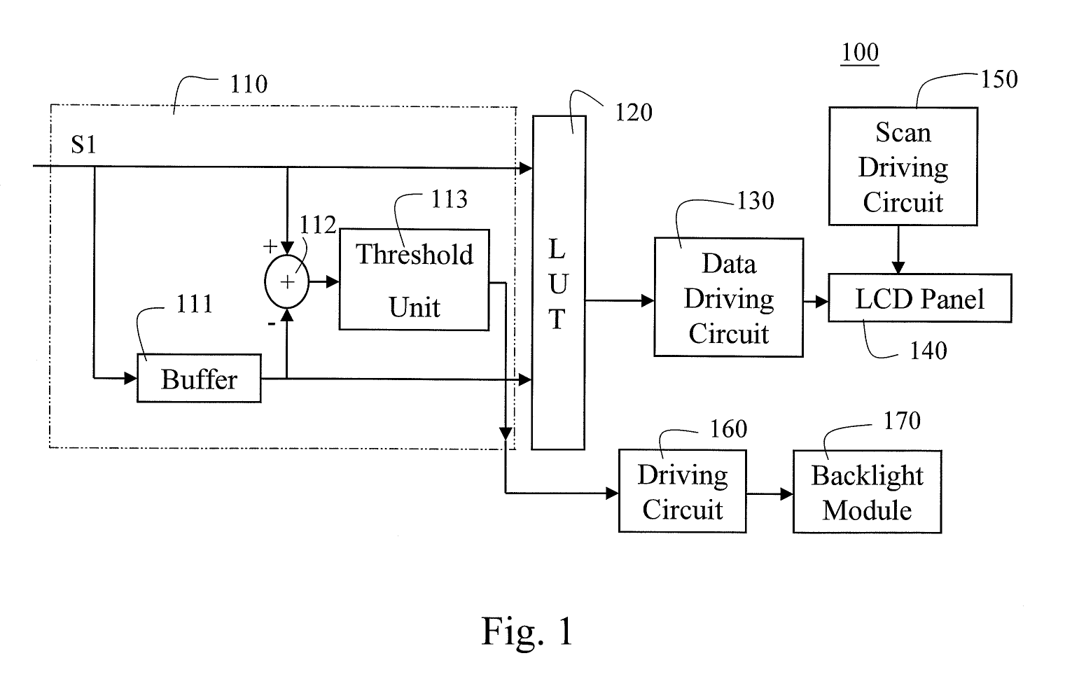

Referring to FIG. 1, a block diagram showing a motion detection apparatus applied to a liquid crystal display device according to a first preferred embodiment of the present invention is illustrated. As shown in FIG. 1, a liquid crystal display device 100 comprises a motion detection apparatus 110, a look-up table (LUT) 120, a data driving circuit 130, a liquid crystal panel 140, a scan driving circuit 150, a driving circuit 160, and a backlight module 170.

The motion detection apparatus 110 comprises a buffer 111, a subtractor 112, and a threshold unit 113. The motion detection apparatus 110 receives a frame image S1 and determines whether a variance between two adjacent frame images is present based on the average of the sum of difference values of each pixel between the two adjacent frame images, thereby determining whether the frame image is a static image or a motion image. If the average of the sum of difference values of each pixel between the two adjacent frame images is less than or equal to a critical value Gₜₕ, the frame image will be identified as a static image. If the average of the sum of difference values of each pixel between the two adjacent frame images is greater than the critical value Gₜₕ, the frame image will be considered variable and thereby identified as a motion image or noise. Calculation of the difference values between the two adjacent frame images is performed on every single pixel.

The aforesaid frame images are not necessarily to be displayed across the whole screen. The following description is exemplified by a SXGA liquid crystal display (LCD). The SXGA LCD has a resolution of 1280*1024 pixels and provides a frame image with 1280*1024*3 pixels. The present invention discloses either calculating the average of the sum of difference values of the 1280*1024*3 pixels between the preceding frame image and the current frame image, or calculating the average of the sum of difference values between the pixels within a block having, for example, 8*8 pixels.

The following description is exemplified by a first frame image received at a first time (hereinafter referred to as the first frame image) and a second frame image received at a second time (hereinafter referred to as the second frame image). The first frame image is stored in the buffer 111. The motion detection apparatus 110 receives the second frame image, and then the subtractor 112 calculates the difference value of each pixel between the first frame image and the second frame image. The result of the difference value of each pixel between the first frame image and the second frame image is sent to the threshold unit 113 for determination of an overdrive value (ODV). Eventually, variation in gray scale values between the two adjacent frame images is determined.

If the average of the sum of difference values between the two adjacent frame images is less than or equal to the critical value Gₜₕ, the frame images will be identified as static images, and thus the driving circuit 160 will be actuated in a way to keep the backlight module 170 on and ready to supply light to the liquid crystal panel 140 steadily without resorting to the scan backlight technique. If the average of the sum of difference values between the two adjacent frame images is greater than the critical value Gₜₕ, the frame images will be considered variable, and thus the driving circuit 160 will be actuated in a way to enable the backlight module 170 to supply light to the liquid crystal panel 140 by the scan backlight technique. Accordingly, the present invention eliminates the flicker which might otherwise occur to static images, wherein light required to display the static images is supplied by the scan backlight technique. Two methods for calculating the critical value Gₜₕ are described as follows:

### 1. Calculate the average velocity V_{avg} of typical images by motion vector algorithms used in human eye experiments, human eye simulation software, or the prior art.

### 2. Calculate the average velocity V_{avg} by making reference to the average velocity of typical images defined by the VESA standard.

### Upon calculation of the average velocity V_{avg} by the two aforesaid methods, the critical value Gₜₕ is calculated with equation (1), using a 1366*768 WXGA resolution.

Gₜₕ=(768*V_{avg}*b)/(1366*768) (1)

In equation (1), b denotes the number of boundaries of a moving image. Where b=2, the moving image has two boundaries, one on the left, the other on the right. In equation (1), b can be set to 1 or any number greater than 2.

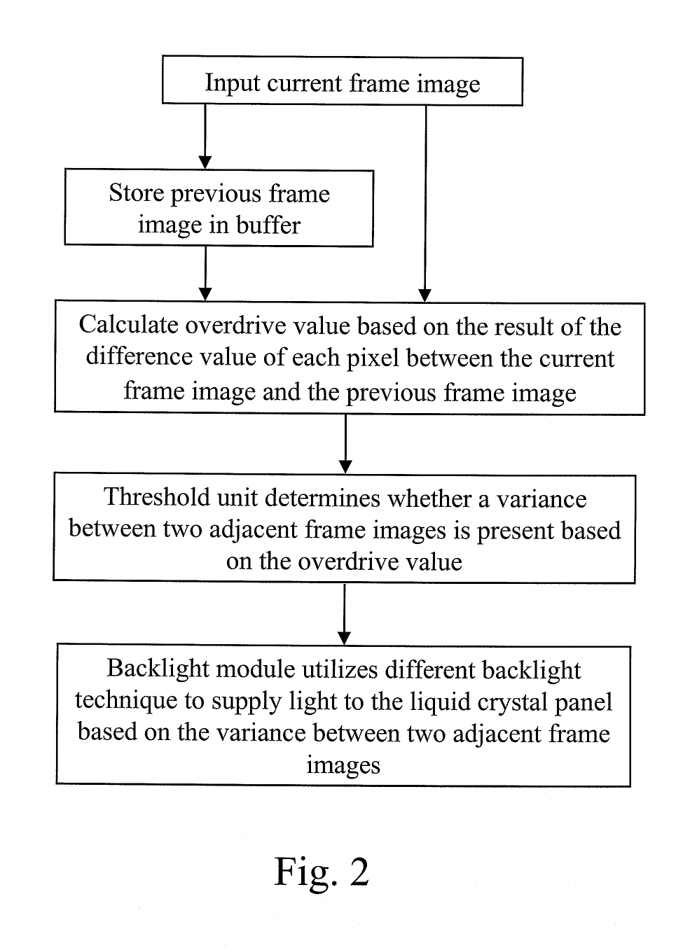

Referring to FIG. 2, which is a flow chart showing how to calculate an overdrive value (ODV) of the first preferred embodiment of the present invention, the method for calculating an overdrive value (ODV) of the first preferred embodiment of the present invention comprises the steps of: storing the preceding frame image in a buffer; calculating an overdrive value (ODV) of the preceding frame image and the current frame image; and determining variation in gray scale values between the two adjacent frame images based on the overdrive value (ODV). The greater the overdrive value (ODV) is, the greater the variation in gray scale values between the two adjacent frame images is, indicating the relatively great variation in a motion image. Therefore, light is provided by scan backlight technique to the liquid crystal panel 140 according to the overdrive value (ODV).

The motion detection apparatus 110 functions using an overdrive-type motion detection technique. The equation of the overdrive-type motion detection technique is as follows:

$$OD M V = \frac{C}{res x * res y} {\sum }_{x = 1}^{res x} {\sum }_{y = 1}^{res y} \vert f ( x , y , n ) - f ( x , y , n - 1 ) \vert \qquad ( 2 )$$

where C denotes a normalized value, resx denotes a horizontal resolution value, resy denotes a vertical resolution value, f(x,y,n) denotes the current frame image, and f(x,y,n−1) denotes the preceding frame image.

Equation (2) expresses the average of the sum of difference in the gray scale value of each pixel between two adjacent frame images, and thus variation in the gray scale values between two adjacent frame images can be determined according to the overdrive value (ODV). The greater the overdrive value (ODV) is, the greater the variation in gray scale values between the two adjacent frame images is, indicating the relatively great variation in a motion image, and vice versa.

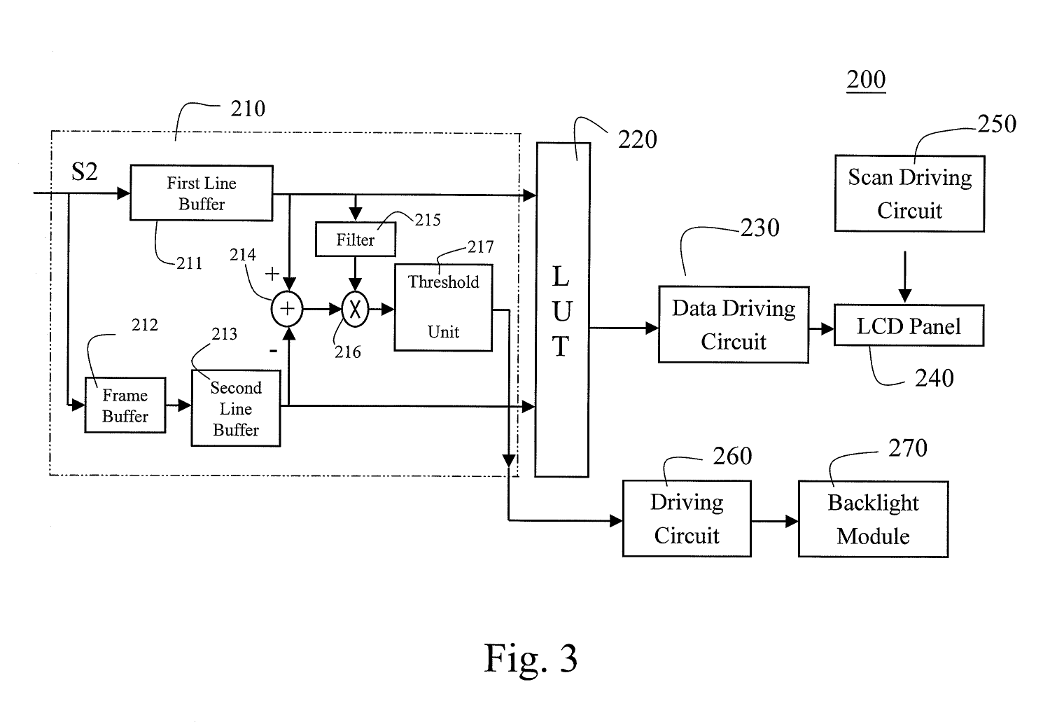

The aforesaid technique distinguishes a motion image from a static image. To better determine the extent of a motion image, the overdrive value (ODV) is multiplied by a gain to obtain a modified overdrive value (MODV), and then the extent of the motion image is determined according to the modified overdrive value (MODV). Referring to FIG. 3, which is a block diagram showing a motion detection apparatus applied to a liquid crystal display device in the second preferred embodiment of the present invention, the liquid crystal display device 200 comprises a motion detection apparatus 210, a look-up table (LUT) 220, a data driving circuit 230, a liquid crystal panel 240, a scan driving circuit 250, a driving circuit 260, and a backlight module 270.

The motion detection apparatus 210 comprises a first line buffer 211, a frame buffer 212, a second line buffer 213, a subtractor 214, a filter 215, a multiplier 216, and a threshold unit 217. The motion detection apparatus 210 receives a frame image S2 and determines whether a variance between two adjacent frame images is present based on the average of the sum of the products of a gain and a difference value of each pixel between the two adjacent frame images, thereby determining whether the frame image is a static image or a motion image. If the average of the sum of the products of a gain and a difference value of each pixel between the two adjacent frame images is less than or equal to the critical value Gₜₕ, the frame image will be identified as a static image. If the average of the sum of the products of a gain and a difference value of each pixel between the two adjacent frame images is greater than the critical value Gₜₕ, the frame image will be considered variable and thereby identified as a motion image or noise.

Similar to that disclosed in the first preferred embodiment, the aforesaid images are not necessarily to be displayed across the whole screen. The following description is exemplified by a SXGA liquid crystal display (LCD). The SXGA LCD has a resolution of 1280*1024 pixels and provides a frame image with 1280*1024*3 pixels. The present invention discloses either calculating the average of the sum of the products of a gain GAIN and a difference value of the 1280*1024*3 pixels between the preceding frame image and the current frame image, or calculating the average of the sum of the products of a gain GAIN and a difference value between the pixels within a block having, for example, 8*8 pixels.

Calculation of the difference values between the two adjacent frame images is performed on every single pixel. Then, the difference value of every single pixel is multiplied by a gain in order to obtain a modified overdrive value (MODV). The gain Gain is figured out, on the basis of a block of n*n pixels, for example, a block of 8*8 pixels, by subtracting the minimum gray scale value of the block from the maximum gray scale value of the block. Alternatively, the gain GAIN is determined by multiplying a block of n*n pixels of a corresponding frame image by a filter value specified for the block of n*n pixels by the filter 215; as a result of multiplication of matrices, low-frequency signals are filtered out, and high-frequency signals remain intact, thus allowing the filter 215 to function as a high-pass filter.

The following description is exemplified by a first frame image received at a first time (hereinafter referred to as the first frame image) and a second frame image received at a second time (hereinafter referred to as the second frame image). The first frame image is stored in the frame buffer 212. After the motion detection apparatus 210 has received the second frame image, the received second frame image is gradually stored in the first line buffer 211, and the first frame image is gradually retrieved from the frame buffer 212 and stored in the second line buffer 213. Then, the subtractor 214 calculates the difference value of each pixel between the first frame image and the second frame image. The gain GAIN is determined using the filter 215 in the manner described above, that is, using the multiplier 216 to multiply the gain by the difference value of each pixel, multiply the gain GAIN by the average of the sum of difference values of each pixel, and calculate the modified overdrive value (MODV). Eventually, variation in gray scale values between the two adjacent frame images is determined according to the overdrive value (ODV). The first line buffer 211 or the second line buffer 213 is selectively, but not necessarily, implemented as an 8-line buffer.

In the event of a zero difference value between the two adjacent frame images, the frame images will be regarded as static images, and thus the driving circuit 260 will be actuated in a way to keep the backlight module 270 on and ready to supply light steadily without resorting to the scan backlight technique. If the difference value between the two adjacent frame images is not equal to zero, the frame images will be considered variable, and thus the driving circuit 260 will be actuated in a way to enable the backlight module 270 to supply light to the liquid crystal panel 240 by the scan backlight technique, and light is provided by scan backlight to the liquid crystal panel 240 according to the modified overdrive value (MODV).

Accordingly, the present invention eliminates the flicker which might otherwise occur to a static image, wherein light required to display the static image is supplied by the scan backlight technique.

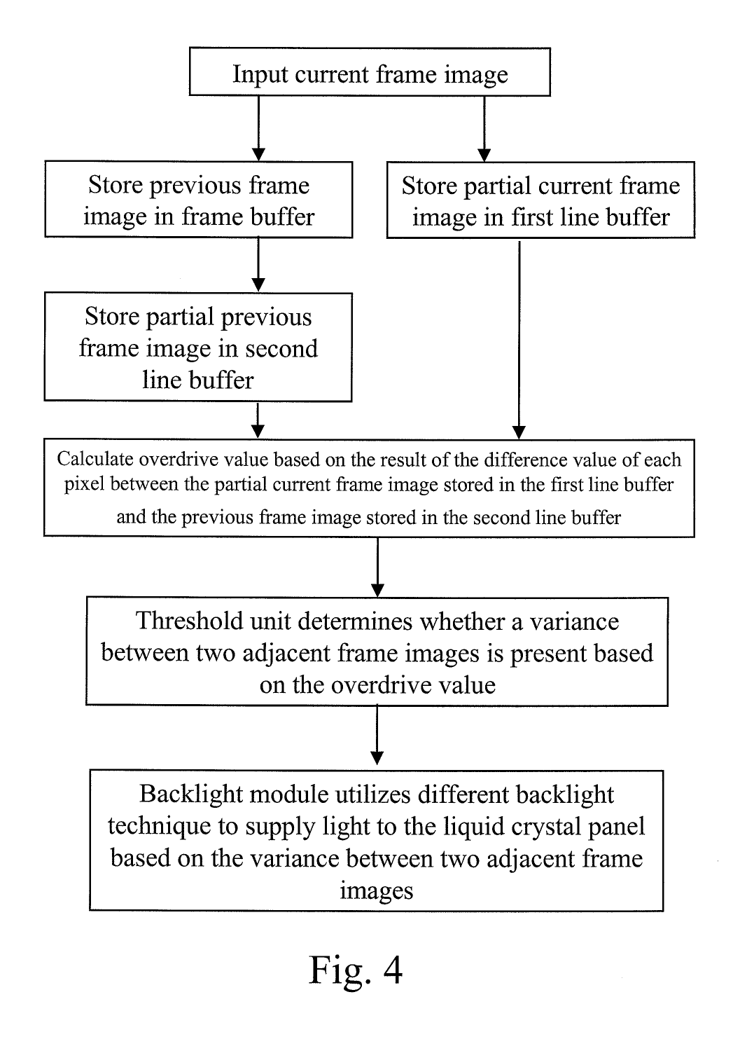

Referring to FIG. 4, which is a flow chart showing the calculation of a modified overdrive value (MODV) according to the second preferred embodiment of the present invention, the method for calculating a modified overdrive value (MODV) of the second preferred embodiment of the present invention comprises the steps of: storing the preceding frame image in a frame buffer 212; storing gradually the current frame image in the first line buffer 211; retrieving gradually the preceding frame image from the frame buffer 212 and then storing gradually the retrieved preceding frame image in the second line buffer 213; calculating a modified overdrive value (MODV) of the preceding frame image and the current frame image; and determining variation in gray scale values between the two adjacent frame images based on the modified overdrive value (MODV). The greater the modified overdrive value (MODV) is, the greater the variation in gray scale values between the two adjacent frame images is, indicating the relatively great variation in a motion image.

The motion detection apparatus 210 functions using a modified overdrive-type motion detection technique. The equation of the modified overdrive-type motion detection technique is as follows:

$$M OD M V = \frac{C}{res x * res y} {\sum }_{x = 1}^{res x} {\sum }_{y = 1}^{resy} GAIN * \vert ( f ( x , y , n ) - f ( x , y , n - 1 ) ) \vert \qquad ( 3 )$$

where C denotes a normalized value, resx denotes a horizontal resolution value, resy denotes a vertical resolution value, f(x,y,n) denotes the current frame image, f(x,y,n−1) denotes the preceding frame image, and GAIN denotes the gain.

Equation (3) expresses the weighted average of the sum of difference in the gray scale value of each pixel between two adjacent frame images, and thus variation in the gray scale values between two adjacent frame images can be determined according to the modified overdrive value (MODV). The greater the modified overdrive value (MODV) is, the greater the variation in gray scale values between the two adjacent frame images is, indicating the relatively great variation in a motion image, and vice versa.

The aforesaid embodiments merely serve as the preferred embodiments of the present invention. The aforesaid embodiments should not be construed as to limit the scope of the present invention in any way. Hence, many other changes can actually be made in the present invention. It will be apparent to those skilled in the art that all equivalent modifications or changes made to the present invention, without departing from the spirit and the technical concepts disclosed by the present invention, should fall within the scope of the appended claims.

One skilled in the art will understand that the embodiment of the present invention as shown in the drawings and described above is exemplary only and not intended to be limited.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A motion detection apparatus, comprising:
a storage unit for storing a first frame image at a first time;
a difference calculation unit electrically connected to said storage unit for receiving said first frame image and a second frame image received at a second time so as to calculate a difference value of each pixel between said first frame image and said second frame image; and
a threshold unit electrically connected to said difference calculation unit for determining an adjustment value and a variance between said first frame image and said second frame image according to the result of said difference value of each pixel between said first frame image and said second frame image.

2. The motion detection apparatus, as recited in claim 1, wherein if the average of the sum of difference values of each pixel between said first frame image and said second frame image is less than or equal to a critical value, said second frame image is identified as a static image and if the average of the sum of difference values of each pixel between said first frame image and said second frame image is greater than said critical value, said second frame image is considered variable and thereby identified as a motion image.

3. The motion detection apparatus, as recited in claim 1, wherein if the average of the sum of difference values of each pixel between said first frame image and said second frame image is less than or equal to a critical value, said second frame image is identified as a static image and thus a driving circuit is actuated to keep a backlight module on to supply light to a liquid crystal panel steadily.

4. The motion detection apparatus, as recited in claim 1, wherein if the average of the sum of difference values of each pixel between said first frame image and said second frame image is greater than said critical value, said second frame image is considered variable and thereby identified as a motion image and thus a driving circuit is actuated to enable a backlight module to supply light to a liquid crystal panel by the scan backlight technique.

5. The motion detection apparatus, as recited in claim 1, wherein said storage unit is a buffer.

6. The motion detection apparatus, as recited in claim 1, wherein said difference calculation unit is a subtractor.

7. The motion detection apparatus, as recited in claim 1, wherein said adjustment value is an overdrive value.

8. The motion detection apparatus, as recited in claim 1, wherein said motion detection apparatus is applied to a liquid crystal display device.

9. A motion detection method, comprising the steps of:
storing a first frame image in a storage unit at a first time;
receiving said first frame image and a second frame image which is received at a second time;
calculating a difference value of each pixel between said first frame image and said second frame image; and
determining a adjustment value and a variance between said first frame image and said second frame image according to the result of said difference value of each pixel between said first frame image and said second frame image.

10. The motion detection method, as recited in claim 9, wherein if the average of the sum of difference values of each pixel between said first frame image and said second frame image is less than or equal to a critical value, said second frame image is identified as a static image and if the average of the sum of difference values of each pixel between said first frame image and said second frame image is greater than said critical value, said second frame image is considered variable and thereby identified as a motion image.

11. The motion detection method, as recited in claim 9, wherein said motion detection method is applied to a liquid crystal display device.

12. The motion detection method, as recited in claim 11, wherein if the average of the sum of difference values of each pixel between said first frame image and said second frame image is less than or equal to a critical value, said second frame image is identified as a static image and thus a driving circuit is actuated to keep a backlight module on to supply light to a liquid crystal panel steadily.

13. The motion detection method, as recited in claim 11, wherein if the average of the sum of difference values of each pixel between said first frame image and said second frame image is greater than said critical value, said second frame image is considered variable and thereby identified as a motion image and thus a driving circuit is actuated to enable a backlight module to supply light to a liquid crystal panel by the scan backlight technique.

14. A motion detection method applied to a liquid crystal display device, comprising the steps of:
storing a first frame image in a frame buffer at a first time;
storing gradually a second frame image in a first line buffer at a second time;
retrieving gradually said first frame image from said frame buffer and then storing gradually said retrieved first frame image in a second line buffer;
calculating a difference value of each pixel between said first frame image which is stored in said second line buffer and said second frame image which is stored in said first line buffer;
generating a gain according to the information of said second frame image which is stored in said first line buffer;
multiply said gain by the difference value of each pixel between said first frame image and said second frame image;
calculating a modified overdrive value by means of multiply said gain by the average of the sum of difference values of each pixel;
determining variation in gray scale values between said first frame image and said second frame image based on said modified overdrive value.

15. The motion detection method, as recited in claim 14, wherein said gain is figured out, on the basis of a block of n*n pixels, by subtracting the minimum gray scale value of said block from the maximum gray scale value of said block.

16. The motion detection method, as recited in claim 14, wherein said gain is figured out by multiplying a block of n*n pixels of said second frame image by a filter value specified for said block of n*n pixels.

17. The motion detection method, as recited in claim 14, wherein if the average of the sum of the products of said gain and a difference value of each pixel between said first frame image and said second frame image is less than or equal to a critical value, said second frame image is identified as a static image and thus a driving circuit is actuated to keep a backlight module on to supply light to a liquid crystal panel steadily.

18. The motion detection method, as recited in claim 14, wherein if the average of the sum of the products of said gain and a difference value of each pixel between said first frame image and said second frame image is greater than a critical value, said second frame image is considered variable and thereby identified as a motion image and thus a driving circuit is actuated to enable a backlight module to supply light to a liquid crystal panel by the scan backlight technique.

19. The motion detection method, as recited in claim 17, wherein if the average of the sum of the products of said gain and a difference value of each pixel between said first frame image and said second frame image is greater than said critical value, said second frame image is considered variable and thereby identified as a motion image and thus a driving circuit is actuated to enable said backlight module to supply light to said liquid crystal panel by the scan backlight technique.
